(19) United States
(12) Patent Application Publication
(10) Pub. No.: US 2004/0237746 A1
(43) Pub. Date: Dec. 2, 2004

(54) Method and apparatus for cutting a sheet material

(76) Inventors: Marissa A. K. Schultz, Racine, WI (US); Robert R. Turvey, Sanford, MI (US); Kristopher W. Gerulski, Racine, WI (US); Bryan L. Ackerman, Freeland, MI (US)

Correspondence Address: S.C. JOHNSON & SON, INC., 1525 HOWE STREET, RACINE, WI, 53403-2236, US

(21) Appl. No.: 10/857,153

(22) Filed: May 28, 2004

Related U.S. Application Data
(60) Provisional application No. 60/474,575, filed on May 29, 2003.
(60) Provisional application No. 60/477,507, filed on Jun. 10, 2003.
(60) Provisional application No. 60/503,430, filed on Sep. 16, 2003.

(51) Int. Cl. B67D 5/56; B26D 5/08

(52) U.S. Cl. 83/614

(57) ABSTRACT

A dispenser for sheet material includes a box having a lid section, a container section, and a wall having a mouth formed between an edge of the lid section and an edge of the container section. The dispenser further includes a cutter attached to the wall of the box on the container section below the mouth, wherein the cutter includes a track assembly and a slider disposed in the track assembly for movement therealong and where the slider includes a blade.

### CROSS REFERENCE TO RELATED APPLICATIONS

This application claims the benefit of U.S. Provisional Application No. 60/474,575, filed May 29, 2003; U.S. Provisional Application No. 60/477,507, filed Jun. 10, 2003; and U.S. Provisional Application No. 60/503,430, filed Sep. 16, 2003.

### REFERENCE REGARDING FEDERALLY SPONSORED RESEARCH OR DEVELOPMENT

Not applicable

### SEQUENTIAL LISTING

Not applicable

### BACKGROUND OF THE INVENTION

1. Field of the Invention

The present invention relates to dispensers for sheet materials, and more particularly, to dispensers for storing and cutting sheet materials.

2. Description of the Background of the Invention

Sheet materials, such as plastic film, metal film and the like, are usually provided to the customer on a roll in a box. The box generally includes a strip of cutting teeth along an edge thereof. When a user desires to utilize a portion of sheet material, he must find the end of the roll, pull the film outwardly, and place the sheet material across the cutting teeth at a desired cutting location. Thereafter, the user must drag the sheet material across the cutting teeth, thereby cutting the sheet material. This process is tedious and rarely results in a uniform tear line across the sheet material.

Chen U.S. Pat. No. 4,787,284 discloses a cutting apparatus for wrap film. The apparatus includes a sliding saddle mounted in a sliding manner in a guiding track slot of a cardboard dispenser box. The sliding saddle includes a T-shaped upper half portion and an I-shaped lower half portion connected by a mid-prop. The I-shaped lower half portion is mounted on the guiding track slot such that the mid-prop and T-shaped upper half portion extend above the slot. The mid-prop includes a razor on a front portion thereof for cutting wrap film.

Chuang U.S. Pat. No. 4,960,022 discloses a plastic film cutter having a slidable cutting means is. The plastic film cutter includes rollers on a bottom surface thereof, wherein the rollers guide the cutter along a sliding furrow attached to a storage box containing a plastic film roll.

Schuler U.S. Pat. No. 6,105,481 discloses a foil dispenser for slicing and dispensing sections of foil. The dispenser includes a dispensing slot for dispensing foil therefrom and a cutting slot, wherein a cutting blade projects through the cutting slot. The cutting blade is situated on a blade holder, which is movable in a blade holder guide. When the dispenser is sufficiently inclined, the cutting blade moves under gravitational forces along the cutting slot to cut a portion of the foil from the roll.

Chen U.S. Pat. No. 6,223,639 discloses an aluminum foil safety fixture for separating aluminum foil in a safe and convenient cutting process. The fixture includes a supporting plate with a slide rail extending from a top edge of the supporting plate. The fixture further includes a push unit assembled in the slide rail, wherein the push unit includes at least one set of slide pressing rollers that keep the foil in a tense form during separation thereof.

Baker, Jr. U.S. Publication No. 2004/0007606 discloses a cutter for cutting sheet materials. The cutter includes a handle, a stem connected to the handle, a cutting blade, and optionally a hook attached to the stem for attaching the cutter to a box. The box includes a top surface, a front flap attached to the top surface, and a front wall, wherein a slot is formed between the front flap and the front wall. The handle straddles the slot such that the stem is disposed in the slot for guiding the cutter along the slot. If the cutter includes a hook, the hook is hooked around a bottom edge of the front flap to prevent the cutter from being removed from the box.

### SUMMARY OF THE INVENTION

According to one aspect of the present invention, a dispenser for sheet material includes a box having a lid section, a container section, and a wall having a mouth formed between an edge of the lid section and an edge of the container section. The dispenser further includes a cutter attached to the wall of the box on the container section below the mouth, wherein the cutter includes a track assembly and a slider disposed in the track assembly for movement therealong and wherein the slider includes a blade.

According to another aspect of the present invention, a dispenser for sheet material includes a box having a lid section, a container section, and a front side having a mouth formed between an edge of the lid section and an edge of the container section. The dispenser further includes a slot formed in the box below the mouth on the container section, wherein the slot is parallel to the mouth. Still further, the dispenser includes a slot formed in the box below the mouth on the container section, wherein the slot is parallel to the mouth. The dispenser further includes a plastic reinforcement member having a flat surface surrounding the slot on an outer surface of the box, wherein the reinforcement member includes first and second tracks extending away from the flat surface adjacent and parallel to the slot on first and second sides thereof. A slider is disposed in the slot, wherein a head portion of the slider protrudes from the slot and includes first and second grooves therein that mate with the first and second tracks.

According to yet another aspect of the present invention, a dispenser for sheet material includes a box having a concave corner portion defined by first and second transverse walls. The dispenser further includes a cutter disposed on the first or second transverse walls of the box and including a track assembly and a slider.

Other aspects and advantages of the present invention will become apparent upon consideration of the following detailed description.

### BRIEF DESCRIPTION OF THE DRAWINGS

FIG. 1 is an isometric view of a box incorporating a cutter according to a first embodiment;

FIG. 2 is a sectional view taken generally along the lines 2-2 of FIG. 1;

FIG. 3 is an isometric view of a first type of slider that can be used with the embodiment of FIG. 1;

FIG. 4 is an elevational front view of the slider of FIG. 3;

FIG. 4A is a side elevational view of an alternative blade arrangement that may be used in the embodiment of FIG. 4;

FIG. 5 is an elevational view similar to FIG. 4 of a second type of slider that can be used in place of the slider of FIG. 3;

FIG. 6 is an isometric view of the upper portion of the slider of FIG. 3 or 5;

FIG. 7 is a plan view of the upper portion of FIG. 6;

FIG. 8 is an isometric view similar to FIG. 1 of a box incorporating a cutter according to a second embodiment;

FIG. 9 is a sectional view taken generally along the lines 9-9 of FIG. 8;

FIG. 10 is an elevational view of a box incorporating a cutter according to a third embodiment;

FIG. 11 is a sectional view taken generally along the lines 11-11 of FIG. 10;

FIG. 12 is an enlarged fragmentary view of a portion of the apparatus shown in FIG. 11;

FIG. 13 is a fragmentary isometric view of a portion of a box incorporating a cutter according to a fourth embodiment;

FIG. 14 is an isometric view of the slider of FIG. 13;

FIG. 15 is an enlarged fragmentary end view of the apparatus of FIG. 13.

### DETAILED DESCRIPTION OF THE PREFERRED EMBODIMENTS

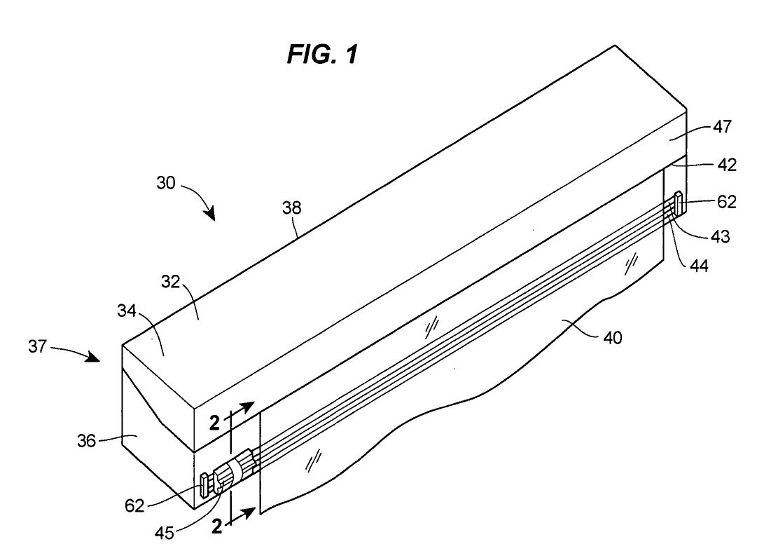

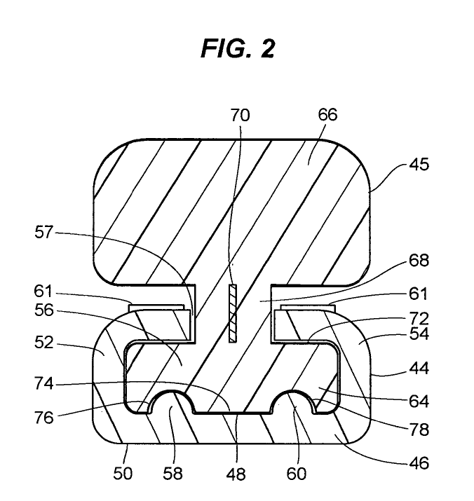

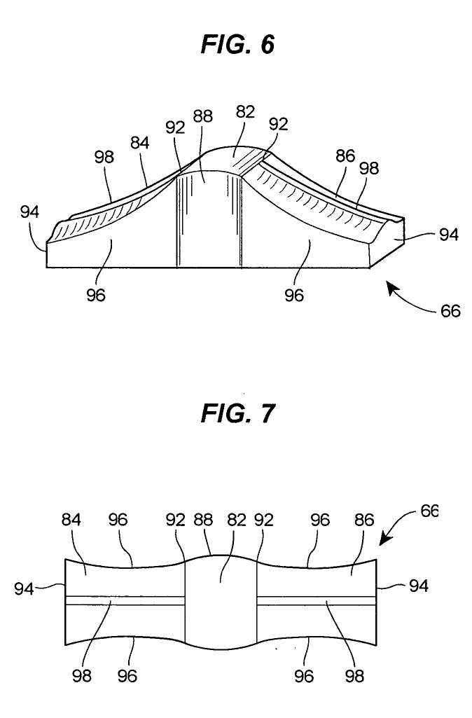

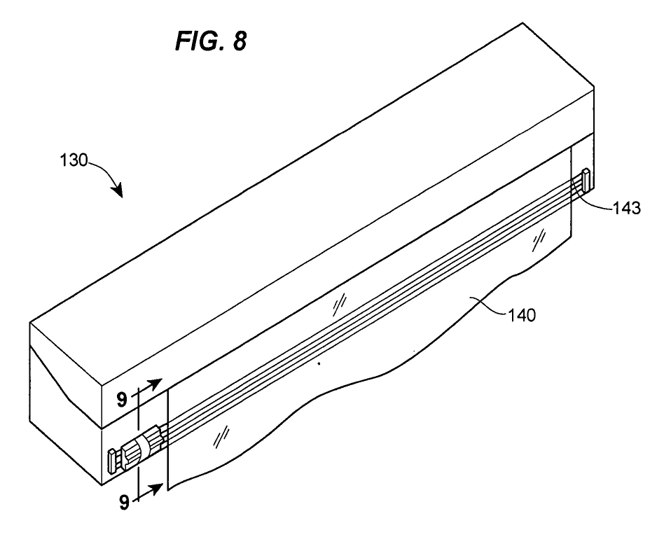

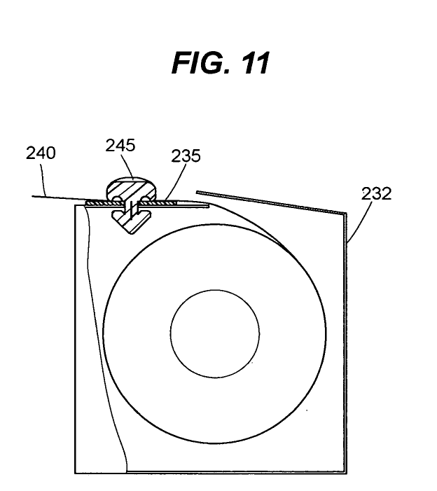

An embodiment of a dispenser 30 for storing and cutting a sheet material is shown in FIGS. 1-7. Referring to FIG. 1, the dispenser 30 includes a box 32 and a cutter 43. The box 32 comprises an integrated lid section 34 and a container section 36. A crease 38 is etched into the back side 37 of the box 32 to act as a hinge enabling the opening and closing of the lid section 34 with respect to the container section 36. The front side 47 of the box includes an opening or mouth 42 formed between an edge of the lid section 34 and an edge of the container section 36. A roll of a sheet material, such as for example, a roll of a thin sheet of transparent thermoplastic 40 is typically placed within the box 32 (shown in FIG. 11) and dispensed through the box mouth 42. It should be noted that while a specific example of a box has been described, the use of other types of boxes adapted to dispense sheet material may also be used without departing from the spirit of the invention.

The cutter 43 generally comprises a track assembly 44 and a slider 45. The track assembly 44 is disposed on the front side 47 of the box 32 in a spaced apart relation below the box mouth 42. The track assembly 44 typically runs along the length of the box 32 and is substantially the same length as the box mouth 42. However, the use of other track assemblies having lengths shorter or longer than that of the box mouth 42 are also considered to be within the scope of the invention.

The track assembly 44 comprises a track base 46 having an upper side 48 and a lower side 50. The track base 46 typically extends the length of the box mouth 42. A pair of opposing inverted L-shaped rails 52, 54 extend upwardly from each side of the upper side 48 and then inwardly towards the center of the track base 46. The rails 52, 54 span the entire length of the track base 46. The rails 52, 54 and the track base 46 define the boundaries of a channel 56. The terminating ends of the rails 52, 54 define a slot 57 therebetween. The opening defined by the slot 57 is relatively narrower than the width of the channel 56 between the rails 52, 54. A pair of tracks 58, 60, integral with the track base 46 extend upwardly from the upper side 48 of the track base 46 and span the entire length of the track base 46. An end stop 62 is disposed at each end of the track assembly 44 and prevent the slider 45 from exiting off the ends of the track assembly 44.

Preferably, the track assembly 44 (with the exception of the end stops 62) comprises a single piece and is manufactured using known plastic extrusion methods. The end stops 62 may be extruded separately and attached to the ends of the track assembly 44, by adhesive or other known means, following the insertion of the slider 45 into the track assembly 44. Alternatively, the slider 45 may be inserted into the track assembly 45 during the extrusion process thereby allowing the end stops 62 to be extruded simultaneously with the rest of the track assembly 44.

Additionally, the cutter 43 includes an attachment means for affixing the cutter to the box 32. The attachment means preferably comprises an adhesive or double sided tape (not shown) disposed on the lower side 50 of the track base 46. While the use of an adhesive or double sided tape has been described as a preferred attachment means, alternative means for attaching the cutter to the box 32 may be employed without departing from the spirit of the invention.

The rails 52, 54 may also include a retaining means for temporarily holding the sheet material 40 in place against the track assembly 44 during the cutting process. The retaining means may comprise an adhesive 61 applied along the upper surface 63 of the rails 52, 54. Alternatively, the rails 52, 54 may be formed from a material having properties to draw the sheet material 40 to the track assembly 46 and loosely hold the sheet material 40 in place during the cutting process. For example, the rails 52, 54 may be imparted with a positive charge to attract a sheet material 40 having a negative charge. While a number of preferred retaining means have been described, alternative means for loosely holding the sheet material 40 in place against the track assembly 46 during the cutting process are also considered to be within the scope of the invention.

The slider 45 comprises a blade 70 and a base 64 integral with a head 66 and a neck 68. The base 62 is formed to complement the shape of the channel 56 to facilitate the gliding action of the slider 45 within the track assembly 44. More specifically, the base 62 includes top 72 and bottom 74 sides, wherein the bottom side 74 of the base 62 further includes a pair of grooves 76, 78 that are cut into the bottom side 74 and complement the tracks 58, 60 of the track assembly 44. The neck 68 extends upwardly from the top side 72 of the base 62 and is formed to fit through the slot 57 of the track assembly 44. The head 66 of the slider 45 extends upwardly from the neck 68. When the slider 45 is inserted into the track assembly 46, the base 64 is substantially contained within the track assembly 46 channel 56 with the neck 68 extending through the slot 57 and the head 66 extending above the upper surface of the rails 52, 54.

In a preferred embodiment, the head 66 comprises a middle portion 82 having two side portions 84, 86 integral with and extending laterally from opposing sides of the middle portion 82. The middle portion 82 has two opposing convex sides 88 disposed between the side surfaces of each of the two side portions 84, 86. A flat bottom surface 80 includes the bottom surface of the middle portion 82 and the bottom surfaces of the two flanking side portions 84, 86. The neck 68 extends downwardly from the flat bottom surface 80 and is integral with the middle portion 82. Each of the side portions 84, 86 comprise a tall section 92, extending from and integral with the middle portion 82, that slopes downward to a distal short end 94; concave sides 96; and a center ridge 98 that spans between the tall end 92 and short end 94. At the short end 94 the ridge 98 extends away from the flat bottom surface 80 further than the short end. As the ridge spans between the ends 92, 94 the differential in extension from the flat bottom surface 80 lessens until the ridge 98 is the same height as the tall end 92. When the slider 45 is in a resting position within the track assembly 46, the flat bottom surface 80 of the slider 45 rests in a spaced apart relationship with respect to the upper surface of the rails 63. While one embodiment of a slider head has been described, other slider designs incorporating alternative slider heads are also considered to be within the scope of the invention.

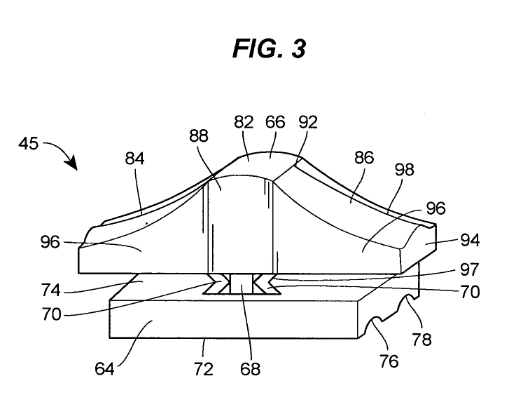

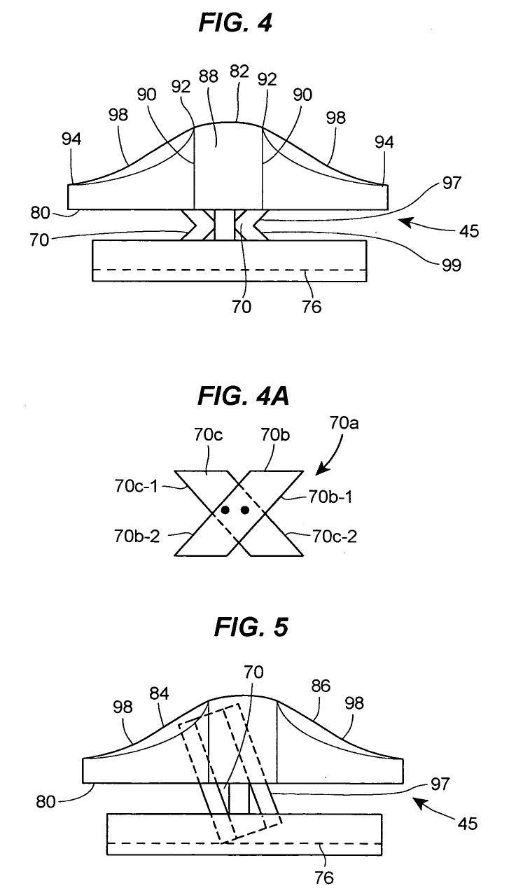

The blade 70 may take many different forms. In the embodiment shown in FIG. 3, two separate blades 70 can be used. In this embodiment, the blades are of a V shape turned sideways with the cutting surface 97 of the blade on the inside of the V. The blades 70 are then mounted between the head 66, the neck 68 and the slider base 64 on opposite sides of the neck 68 whereby when the slider 45 is inserted into the track assembly 44 the cutting surfaces 97 of the blades face in opposite directions parallel with the rails 52, 54. In a similar embodiment, seen in FIG. 4, outer portions 99 of the cutting surface 97 adjacent the head 66 or the slider base 64 of the slider 45 are dulled in order to decrease the likelihood of anything other than the sheet 40 coming in contact with the cutting surfaces 97.

FIG. 4A illustrates an alternative blade arrangement 70a that may be used in the embodiment of FIG. 4. The blade arrangement 70a includes first and second blade portions 70b, 70c having sharpened leading and trailing edges, 70b-1, 70b-2 and 70c-1, 70c-2, respectively. The blade portions, 70b, 70c may be joined together in any suitable fashion, such as by tack welds or other suitable fasteners, or the blade portions 70b, 70c may not be joined together. In any event, the blade portions 70b ,70c are molded into the upper portion 66 and the base 64. The leading and trailing edges 70b-1, 70b-2 and 70c -1, 70c-2 may have dulled potions as noted in the embodiment of FIG. 4.

Alternatively, the blade 70 can be of a single blade design as seen in FIG. 5. The blade 70 is a rectangular design place aligned in the slider 45 integral with the slider base 64, the head 66, and neck 68 and presenting exposed cutting surfaces 97 aligned similar to the blades 70 above. The difference in this embodiment is that due to the rectangular shape of the blade a straight rather then V-shaped cutting surface 97 is presented on either side of the neck 68. Furthermore, the blade 70 is preferably integral with the slider 45 at an angle other parallel with the neck 68, thus presenting an angled rather than perpendicular cutting surface 97 to the sheet 40.

In use, the user pulls the sheet 40 over the rails 53, 54 whereby the sheet 40 comes in contact with the adhesive 61 on top 63 of the rails 52, 54. The slider 45 is then moved by the user across the length of the rails 52, 54 thereby bringing the cutting surface 97 in contact with the sheet 40 and cutting it. The design of the head 66 of the slider 45 encourages the user to put pressure on the side of the slider opposite the direction of movement, thereby minimizing the plowing effect of crumpling the sheet 40 before the blade 70 can contact the sheet 40.

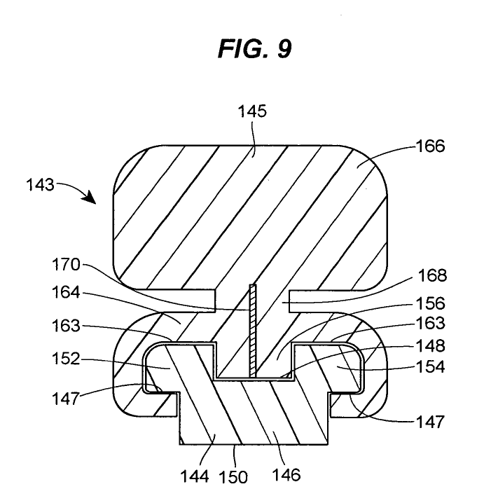

Referring now to FIGS. 8 and 9 another embodiment of a dispenser 130 is seen. This dispenser design is identical to the design shown in FIG. 1 with the exception of the cutter 143 design. In this embodiment the cutter 143 comprises a track assembly 144 and a slider 145. The track assembly 144 comprises a track base 146 which has upper 148 and lower 150 sides. Two rails 152, 154 extend both horizontally and vertically from the upper side 148 of the track base 146 and span the length of the track base 146. The horizontal extension of the rail 152, 154 thereby creates lips 147 adjacent the track base 146. Also, the rails 152, 154 define a channel 156 between them. However since the rails 152, 154 are rectangular in cross section rather than L shaped there is no slot in this embodiment. Similar to the dispenser 30 shown in FIG. 1, the top 163 of the rails 152, 154 may include a retaining means, such as an adhesive, for partially restraining a sheet 40.

The slider 145 comprises a base 164, a head 166, a neck 168 and a blade 170. The base 164 is formed in an M shape whereby when the slider 145 in placed on the rails 152, 154 the inner part of the M shape fits the shape of the channel 156 and the outer parts of the M shape envelop the rails 152, 154 and lips 147. The base 164 therefore fits the track assembly 144 securely when slid onto the rails 152, 154. The remainder of the slider is similar in design to the slider described in relation to FIG. 1.

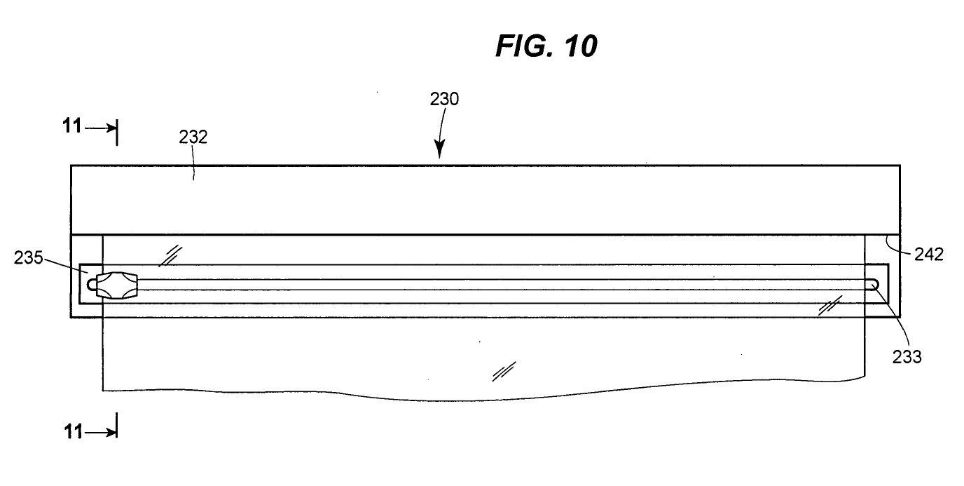

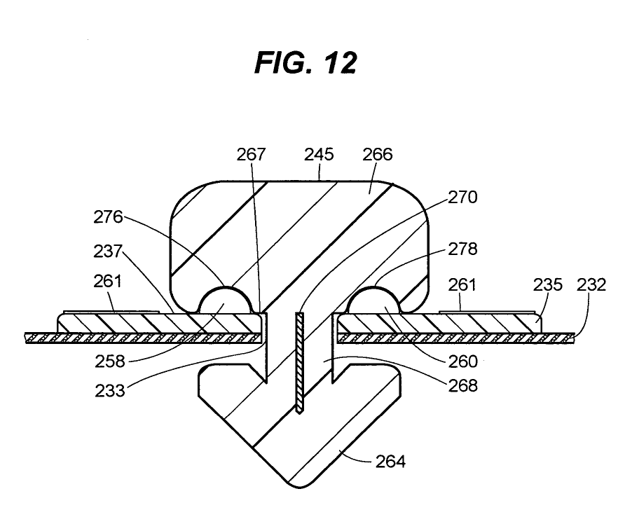

A third embodiment of a dispenser 230 is seen in FIGS. 10-12. In this embodiment the box 232 further includes a slot 233. The slot 233 is parallel to the mouth 242 of the box 232 and extends substantially the length of box 232. Surrounding the slot 233 on the outer surface of the box 232 is a plastic reinforcement 235, which in this embodiment serves a similar role to the track assemblies 44, 144 of the two previously discussed embodiments. Preferably, the reinforcement has a flat surface 237 that extends away from the slot 233 to strengthen the box further. Also preferably the flat surface 237 includes a pair a tracks 258, 260 extending away from the box 232, substantially the length of the slot 233, and parallel to the slot 233. The flat surface 237 can also include a retaining means described above such as adhesive 261 opposite the box.

The dispenser 230 also includes a slider 245. The slider 245 comprises a base 264, a neck 268, a head 266, and a blade 270. The base 264 of the slider 245 is a generally V shaped form. The shape of the V allows the slider 245 to be easily inserted through the slot 233 while then preventing the slider 245 from being easily removed. The neck 268 extends from the interior center of the V-shaped base 264 and is shaped to fit inside the slot 233 and allow movement down the length of the slot 233. The head 266 extends from the side of the neck 268 opposite the base 264. A lower surface 267 of the upper portion 266 extends away from the neck 268 and includes a groove 276, 278 on either side of the neck 268. The grooves 276, 278 are positioned and sized to fit over the tracks 258, 260 of the reinforcement 235. The shape of the remainder of the upper portion 266 is similar to the shapes described in relation to FIG. 1.

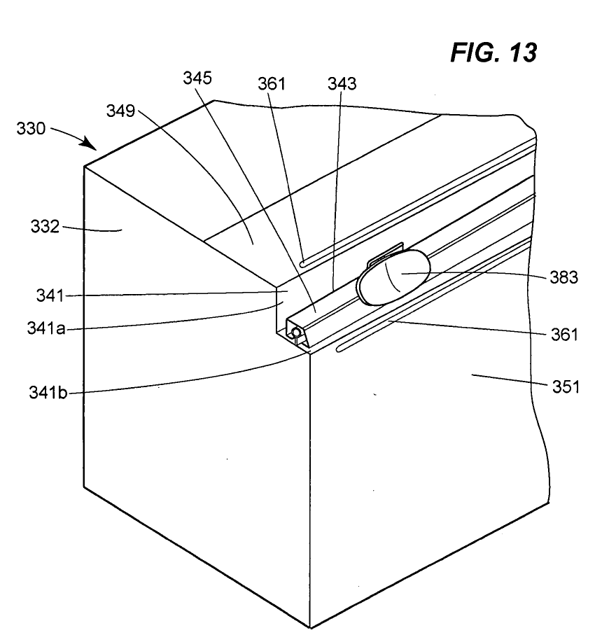

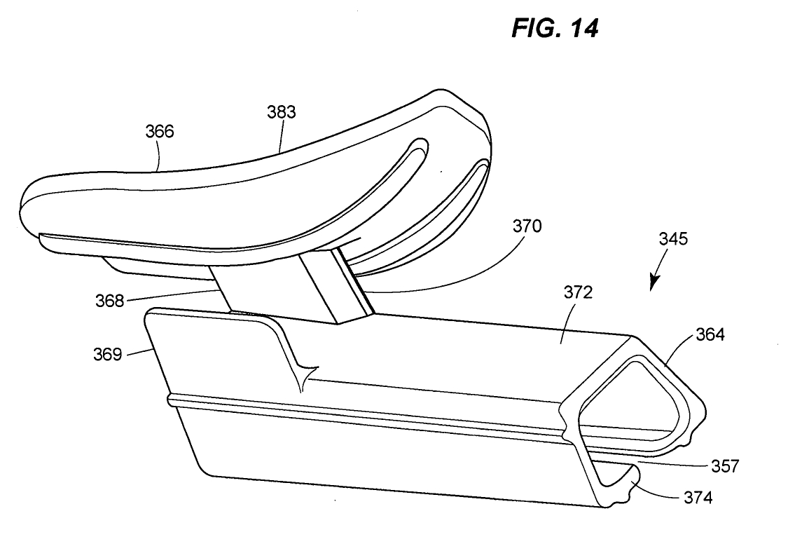

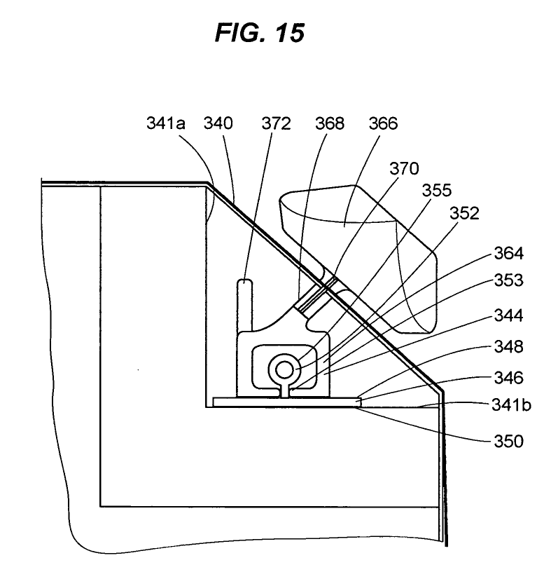

Referring now to FIGS. 13-15 a fourth embodiment of a dispenser 330 is depicted. The box 332 includes a cut out corner 341 which comprises a vertical shelf 341a and a horizontal shelf 341b. The dispenser 330 also includes a cutter 343 which comprises a track assembly 344 and a slider 345. To assist holding the sheet 340 in place the box 330 also preferably includes retaining means for restraining the sheet 340 described above. In this embodiment the means takes the form of adhesive strips 361 on the horizontal 349 and vertical 351 surfaces of the box adjacent the cut out corner 341.

The track assembly 344 is attached to the horizontal shelf 341b and extends substantially the length of the shelf. The track assembly 344 includes a base 346, having upper 348 and lower 350 sides, and a rail 352. The lower side 350 of the base 346 is attached to the horizontal shelf 341b by an adhesive or double sided tape (not shown). The rail 352 extends away from the horizontal shelf 341b on the upper side 348 of the base 346 and includes a leg portion 353 and a tube portion 355. The leg portion 353 extends from the base 346 and attaches to and supports the tube portion 355, which is a hollow tube that guides the slider 345. All parts of the track assembly 344 are preferably extruded thermoplastic; however other materials could be utilized.

The slider 345 depicted in this embodiment differs from previously described sliders in that the slider is unidirectional in the cutting it provides, however it is to be understood that the features of all of the described cutters are interchangeable. The slider 345 comprises a base 364, a head 366, a neck 368, and a blade 370. The base 364 is generally tubular in construction in order to fit around the tube portion 355 of the lower portion 344 and has top side 372 and bottom side 374. The base 364 further includes a slot 357 located on the bottom side 374 of the slider 345 and extending the entire length of the slider 345. The slot 357 is of dimensions to fit around the leg portion 355 of the rail 352. The base 364 also preferably includes a stabilizer arm 369 extending outwardly from the top side 372 closest to the vertical shelf 341 a and extending parallel to the vertical shelf 341a. The neck 368 extends outwardly from the top side 372 of the base 364 furthest from the vertical shelf 341a at an angle approximately 45 degrees from both the vertical shelf 341a and the horizontal shelf 341b. This angle allows the most room between the head 366 and the box 332, thus giving the user freedom of movement when utilizing the dispenser 330. The head 366 is integral with the neck 368 and is shaped with an upward contour 383 to receive a user's finger and encourage unidirectional cutting by the direction of the contour 383.

In any of the forgoing embodiments, the upper portions 66 and/or the base 64 of the slider may be modified to provide overhanging projections, step-like configurations, tabs, or the like that limit the ability of a user to directly contact portions of the blade 70.

The blade 370 is integral with the base 364, head 366, and neck 368 and extends from one side of the neck 368. The blade 370 is disposed to present an angled cutting surface 397 toward the sheet 340 when the slider is fitted to the rail 352.

### INDUSTRIAL APPLICABILITY

In operation, the user pulls the sheet 340 from the mouth 342 of the box 332 to the desired length. The user then pulls the sheet 40 down so the sheet 40 comes in contact with both adhesive strips 361. With the film held in place the slider 345 is pushed down the rail 352 cutting the sheet 340. Once the slider 345 has completely severed the sheet 340 the user pulls the cut sheet from the adhesive strip 361 for use.

Numerous modifications to the present invention will be apparent to those skilled in the art in view of the foregoing description. Accordingly, this description is to be construed as illustrative only and is presented for the purpose of enabling those skilled in the art to make and use the invention and to teach the best mode of carrying out same. The exclusive rights to all modifications which come within the scope of the appended claims are reserved.

We claim:

1. A dispenser for sheet material, comprising:
a box including a lid section, a container section, and a wall having a mouth formed between an edge of the lid section and an edge of the container section; and
a cutter attached to the wall of the box on the container section below the mouth, wherein the cutter includes a track assembly and a slider disposed in the track assembly for movement therealong and wherein the slider includes a blade.

2. The dispenser of claim 1, wherein the track assembly includes a track base and two inverted L-shaped rails extending from an upper side of the track base to define a channel and wherein ends of the rails define a slot.

3. The dispenser of claim 2, wherein the slider includes a base portion, a neck portion, and a head portion and wherein the base portion is disposed in the channel, the neck portion is disposed in the slot, and the head portion is disposed above the track assembly.

4. The dispenser of claim 3, wherein the blade of the slider is disposed on opposite sides of the neck portion and extends parallel to a longitudinal extent of the track assembly.

5. The dispenser of claim 4, wherein the blade of the slider includes two blade portions that are v-shaped.

6. The dispenser of claim 1, wherein the track assembly includes stops at ends thereof to retain the slider therein.

7. The dispenser of claim 1, wherein the track assembly is attached to the front side of the box by an adhesive or double-sided tape.

8. The dispenser of claim 1, wherein the track assembly includes a track base and two rectangular rails extending from an upper side of the track base to define a channel between the rails and further define lips under the rails adjacent the track base.

9. The dispenser of claim 8, wherein the slider includes an M-shaped base portion, a neck portion, and a head portion and wherein the slider is disposed on the rails such that an inner portion of the M-shaped base portion fits the shape of the channel and outer portions of the M-shaped base portion envelop the rails and the lips.

10. A dispenser for sheet material, comprising:
a box including a lid section, a container section, and a front side having a mouth formed between an edge of the lid section and an edge of the container section;
a slot formed in the box below the mouth on the container section, wherein the slot is parallel to the mouth;
a plastic reinforcement member having a flat surface surrounding the slot on an outer surface of the box, wherein the reinforcement member includes first and second tracks extending away from the flat surface adjacent and parallel to the slot on first and second sides thereof; and
a slider disposed in the slot, wherein a head portion of the slider protrudes from the slot and includes first and second grooves therein that mate with the first and second tracks.

11. The dispenser of claim 11, wherein the slider further includes a neck portion disposed in the slot and a base portion disposed below the slot in the box.

12. The dispenser of claim 12, wherein the base portion of the slider is V-shaped to allow movement of the slider along the slot, but prevent the slider from being removed from the slot.

13. The dispenser of claim 12, wherein the slider further includes a blade extending from first and second sides of the neck portion in a direction parallel to a longitudinal extend of the slot.

14. The dispenser of claim 11, wherein the flat surface of the plastic reinforcement includes retaining means for retaining the sheet material in a desired position.

15. A dispenser for sheet material, comprising:
a box having a concave corner portion defined by first and second transverse walls; and
a cutter disposed on the first or second transverse walls of the box and including a track assembly and a slider.

16. The dispenser of claim 17, wherein the track assembly includes a base and a rail extending from an upper side of the base, wherein the rail includes a leg portion and a tube portion.

17. The dispenser of claim 18, wherein the slider includes a tubular base portion that fits around the tube portion of the rail and a slot that fits around the leg portion of the rail.

18. The dispenser of claim 19, wherein the slider includes a neck portion that extends from a top side of the tubular base portion at an angle of about 45 degrees with respect to the horizontal and vertical shelves and wherein a blade extends from a least one side of the neck parallel to the track assembly.

19. The dispenser of claim 20, wherein the slider includes a head integral with the neck for receiving a finger of a user for movement thereof.

20. The dispenser of claim 17, wherein a wall of the box includes retaining means thereon for retaining the sheet material in a desired position.
